(19) United States
(12) Patent Application Publication
(10) Pub. No.: US 2010/0177003 A1
(43) Pub. Date: Jul. 15, 2010

(54) PATCH ANTENNA

(76) Inventor: MOHAMMAD BASHIR, Niefern-Oschelbrownn (DE)

Correspondence Address: WALTER A. HACKLER, Ph.D.;PATENT LAW OFFICE, SUITE B, 2372 S.E. BRISTOL STREET, NEWPORT BEACH, CA, 92660-0755, US

(21) Appl. No.: 12/685,221

(22) Filed: Jan. 11, 2010

(30) Foreign Application Priority Data
Jan. 13, 2009 (DE) 10 2009 005 045.0

(51) Int. Cl. H01Q 19/12

(52) U.S. Cl. 343/834

(57) ABSTRACT

A patch antenna includes an electrically conductive ground plane, an electrically conductive radiator plane, a dielectric arranged between the ground plane and the radiator plane, and a reflector which surrounds the dielectric and which progressively opens in a direction away from the ground plane toward the radiator plane.

The present invention relates to a patch antenna. Patch antennas of that kind are known and are in use especially on automobiles.

Patch antennas advantageously can be made small and compact so that they are suited for being mounted on automobiles without impairing their aesthetic appearance. However, flat patch antennas, which can be mounted for example below a glass roof or a plastic roof of a motor vehicle, normally have a response characteristic inferior to that of turnstile antennas or quadrifilar helix antennas, for example, in an angular range of 50° to 70° elevation.

An object of the invention is therefore to show how the response characteristics of a patch antenna of the before-mentioned kind can be improved, especially in the stated angular range.

### SUMMARY OF THE INVENTION

A patch antenna according to the invention comprises a reflector that surrounds the dielectric and that opens progressively in a direction away from the ground plane toward the radiator plane. The area enclosed by the reflector therefore increases in proportion to the rising distance from the ground plane. It is possible in this way to improve the omnidirectional response pattern while at the same time keeping the design flat.

In principle, the reflector of a patch antenna according to the invention may open by steps. Preferably, however, the reflector will open continuously, e. g. so that a sectional view will show a curved, especially a parabolic, configuration. Giving the reflector a continuously opening design can be achieved with particular advantage by giving the reflector a reflection surface that extends obliquely relative to the ground plane. The reflector surface of a circular patch antenna then preferably has the shape of a truncated cone. In the case of a rectangular patch antenna, especially a square patch antenna, the reflector then has a reflector surface, for each side of the patch antenna, that extends obliquely relative to the ground plane so that the reflector has the shape of a truncated pyramid, for example.

An advantageous modification of the invention provides that the reflector is connected with the ground plane in an electrically conductive manner. According to an especially preferred design, the reflector is formed as a single piece together with the ground plane; for example, the reflector and the ground plane may form together a trough. Such a trough can be obtained, for example, by a metallic coating on a molded plastic part, or may be made from sheet metal.

According to an advantageous modification of the invention, the reflector extends beyond the radiator plane. In that way, the directional characteristic can be considerably improved by a very minor increase in height.

A patch antenna according to the invention is suited especially for the microwave range, especially for reception in the SDARS frequency range, especially in the range of 2.3 GHz to 2.4 GHz, and can be mounted, as a result of its flat structure, for example below a glass roof or a plastic roof of an automobile, without any reinforcing frame.

### BRIEF DESCRIPTION OF THE DRAWINGS

Further details and advantages of the invention will be described hereafter with reference to one embodiment and to the attached drawings in which:

FIG. 1 shows a diagrammatic representation of one embodiment of a patch antenna according to the invention;

FIG. 2 shows a diagrammatic sectional view of the embodiment of FIGS. 1; and

FIG. 3 shows a sheet-metal blank for the ground plane and the reflector of the patch antenna illustrated in FIG. 1.

### DETAILED DESCRIPTION

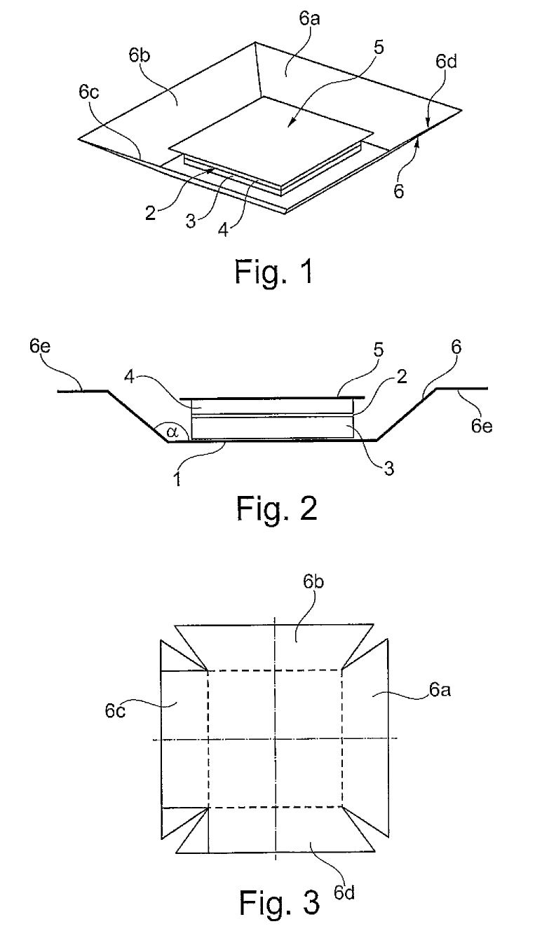

The patch antenna illustrated in FIGS. 1 and 2 has an electrically conductive ground plane 1, an electrically conductive radiator plane 2 and a dielectric 3 material arranged between the ground plane and the radiator plane. An additional dielectric layer 4 with an additional radiator plane 5, forming a stray radiator element, are arranged on the radiator plane 2.

The dielectric 3 is surrounded by a reflector 6 which opens progressively in a direction away from the ground plane 1 toward the radiator plane 2. The reflector 6 has four reflector surfaces 6a, 6b, 6c, 6d, which extend obliquely relative to the ground plane 1 and which accordingly show the form of a truncated pyramid. The reflector surfaces 6a, 6b, 6c, 6d and the ground plane 1 enclose between them an angle α of 120° to 150°, especially of 130° to 140°. In the illustrated embodiment, the angle α is 135°.

As can be seen especially in FIG. 2, the reflector 6 extends beyond the radiator plane 2, and also beyond the additional radiator plane 5. This means that the reflector 6 extends over a greater length, in the stacking direction of the parallel layers 2, 3, 4, 5 of ₜhe patch antenna, than the stacked layers of the patch antenna, which may have a height of 3 to 4 mm for example.

The reflector 6 is connected with the ground plane 1 in an electrically conductive way, being formed integrally with the ground plane 1 in the illustrated embodiment. For example, the reflector 6 and the ground plane 1 may be configured as metallic surfaces on a molded plastic part. There is, however, also the possibility to form the reflector 6 and the ground plane 1 from sheet metal, for example by deep-drawing, and to give them the form of a trough. Preferably, the reflector 6 and the ground plane 1 are formed from a piece of sheet metal the lateral portions of which are folded obliquely upward to form the reflector surfaces 6a, 6b, 6c, 6d. FIG. 3 shows one embodiment of such a sheet-metal part. The square indicated by broken lines defines the lines about which the lateral portions are folded upward to form the reflector surfaces 6a, 6b, 6c, 6d.

On its end proximate to the ground plane 1, the reflector 6 is arranged at a distance from the dielectric 3. The reflector surfaces 6a, 6b, 6c, 6d therefore have a considerable distance from the dielectric 3 also on their ends facing toward the ground plane 1. Preferably, that distance is equal to at least 5%, maximally 25%, of the distance between opposite points on the edges of the dielectric 3. In the illustrated embodiment, the distance between that end of the reflector, which faces the ground plane 1, and the dielectric 3 is equal to approximately 15% of the length of the sides of the dielectric 3.

The additional radiator plane 5 projects on all sides beyond the radiator plane 3. However, that projection is smaller than the distance of the reflector 6 from the dielectric 3, at that end of the reflector which faces the ground plane 1.

The reflector 6 may be provided with mounting portions 6e which, as shown in FIG. 2, may follow the ends of the reflector surfaces 6a, 6b, 6c, 6d that face away from the ground plane 1, and may serve for mounting the patch antenna on an automobile. The mounting portions 6e may serve, for example, as bonding surfaces and/or may have openings for screws or rivets.

### LIST OF REFERENCE NUMERALS

1 Ground plane
2 Radiator plane

### 3 Dielectric

4 Dielectric layer
5 Radiator plane

### 6 Reflector

6a-d Reflector surfaces
6e Mounting portions

What is claimed is:

1. Patch antenna comprising
an electrically conductive ground plane;
an electrically conductive radiator plane,
a dielectric arranged between the ground plane and the radiator plane, and
a reflector which surrounds the dielectric and which progressively opens in a direction away from the ground plane toward the radiator plane.

2. The patch antenna as defined in claim 1, wherein the reflector is connected with the ground plane in an electrically conductive manner.

3. The patch antenna as defined in claim 1, wherein the reflector is arranged at a distance from the dielectric at its end that is proximate to the ground plane.

4. The patch antenna as defined in claim 3, wherein the distance is equal to at least 5% of the distance between opposite points on the edges of the dielectric.

5. The patch antenna as defined in claim 3, wherein the distance is at most 25% of the distance between opposite points on the edges of the dielectric at the end of the reflector that is proximate to the ground plane.

6. The patch antenna as defined in claim 1, wherein the reflector opens continuously.

7. The patch antenna as defined in claim 1, wherein the reflector comprises a reflector surface that extends obliquely relative to the ground plane.

8. The patch antenna as defined in claim 7, wherein the reflector surface and the ground plane enclose between them an angle of 120° to 150°, preferably of 130° to 140°.

9. The patch antenna as defined in claim 7, wherein the reflector surface and the ground plane enclose between them an angle of 130° to 140°.

10. The patch antenna as defined in claim 1, wherein the reflector extends beyond the radiator plane.

11. The patch antenna as defined in claim 1, further comprising an additional dielectric layer disposed on the radiator plane with an additional radiator plane disposed thereon.

12. The patch antenna as defined in claim 1, wherein the reflector extends beyond the additional radiator plane.

13. The patch antenna as defined in claim 1, wherein the reflector is formed as a single piece together with the ground plane.

14. The patch antenna as defined in claim 1, wherein the reflector and the ground plane are made from sheet metal.

15. The patch antenna as defined in claim 1, wherein the reflector and the ground plane together form a trough.

16. The patch antenna as defined in claim 11, wherein the additional radiator plane projects laterally beyond the radiator plane.
